(19) United States
(12) Patent Application Publication
(10) Pub. No.: US 2011/0270902 A1
(43) Pub. Date: Nov. 3, 2011

(54) Efficient Multipliers Based on Multiple-Radix Representations

(76) Inventors: Vassil S. Dimitrov, Calgary (CA); Kimmo U. Järvinen, Espoo (FI); Jithra Adikari, Waterloo (CA)

(21) Appl. No.: 13/035,467

(22) Filed: Feb. 25, 2011

Related U.S. Application Data
(60) Provisional application No. 61/308,846, filed on Feb. 26, 2010.

(51) Int. Cl. G06F 7/52

(52) U.S. Cl. 708/204

(57) ABSTRACT

Methods and apparatus for multiplying integers using a double-base numbering system are presented. In one embodiment, a method includes splitting a first integer into a plurality of binary blocks. The method may also include encoding the plurality of binary blocks into a plurality of encoded blocks in a double-base numbering system. Additionally, the method may include producing a plurality of multiples of a second integer. The method may also include producing a plurality partial results. The method may include selectively shifting the plurality of partial results to generate a plurality of shifted partial results, and adding the plurality of partial results and the shifted partial results to create the product of a plurality of integers.

### RELATED APPLICATION

This application claims priority to U.S. Provisional Application Ser. No. 61/308,846 filed Feb. 26, 2010, the entire text of which is specifically incorporated herein by reference without disclaimer.

### BACKGROUND OF THE INVENTION

1. Field of the Invention

This invention relates to processor-based computation and more particularly relates to efficient multipliers based on multiple-radix representations.

2. Description of Related Art

In the mid-1950s Kolmogorov [1] made a conjecture that any multiplication algorithm will require Ω(k²) elementary bit operations, where k is the binary length of the multiplicands. This conjecture has been disproved in a constructive manner by Karatsuba [2-4] who proposed an algorithm that uses O(k^{1.585}) elementary bit operations. Karatsuba's multiplication algorithm has led to the discovery of many similar algorithms, perhaps, the most famous example is the Strassen's matrix multiplication algorithm [5] which effectively demonstrated that one can multiply two n×n matrices by using o(n³) multiplications and additions. Researchers in the 1960s tried to improve, asymptotically, Karatsuba's multiplication algorithm. In 1971 Schönhage and Strassen published an algorithm [6] with asymptotic complexity O(k log k log log k); that is, demonstrating that the multiplication can be done in nearly linear time. For almost 40 years this result has not been improved; however, in 2007 Fürer [7] designed an algorithm with lower asymptotic complexity, namely, O(k log k log log . . . log k) operations. Under some restrictive assumptions it is possible to prove [8] a lower bound of Ω(k log k) elementary bit operations.

The above mentioned algorithms (Karatsuba's, Schönhage-Strassen's and Fürer's) all have sub-quadratic complexity. However, the implicit constant of these algorithms, associated with the big-O notation, is very large and severely limits the applicability of these algorithms to problems of practical importance. For example, Karatsuba's multiplication outperforms classical shift-and-add algorithm if the size of the multiplicands is around 1000 bits, which makes it suitable for specific cryptographic applications. The algorithms by Schonhage-Strassen and Führer are useful if one deals with extremely large numbers. Applications include computational number theory and computations associated with the search of large Mersenne primes and finding divisors of Fermat numbers. In those cases researchers deal with numbers having more than one million decimal digits.

Since the introduction of the DBNS in 1995 [18] it has found various applications in digital signal processing and cryptography. Initial applications in the field of digital signal processing [19-25] have shown that DBNS, if properly applied, can lead to very serious improvements over the standard binary number system designs. The first chips operating with the DBNS [20] have been aimed at implementing a 15-tap digital filter. Ever since, a large number of fabricated design [19, 21, 22] have demonstrated that this number system is ideally suited for inner product computations and often outperform the equivalent binary design by a considerable margin in terms of every figure of merit. During the interval 2005-2009, researchers in the area of public key cryptography have discovered that the attractive features of the DBNS make it extremely well suited for cryptographic applications, particularly in implementing point and multiple point multiplications over elliptic curves.

### SUMMARY OF THE INVENTION

Embodiments of a method for multiplying integers in a processor are presented. In one embodiment, the method includes splitting in an integrated circuit a first integer into a plurality of binary blocks. The method may also include encoding the plurality of binary blocks into a plurality of encoded blocks. Additionally, the method may include producing a plurality of multiples of a second integer. The method may also include producing a plurality of partial results from the plurality of encoded blocks and the plurality of multiples. In addition, the method may include selectively shifting the plurality of partial results to generate a plurality of shifted partial results, and adding the plurality of partial results and the shifted partial results to create the product of the first integer and the second integer.

In a further embodiment, producing the partial results may include selecting a first multiple of the second integer in response to a first subset of the encoded block, and selecting a second multiple of the second integer in response to a second subset of the encoded block. Additionally, producing the partial result may include shifting the first multiple of the second integer in response to a third subset of the encoded block, and shifting the second multiple of the second integer in response to a fourth subset of the encoded block. In still a further embodiment, producing the partial results may include selectively adding or subtracting the first shifted multiple of the second integer and the second shifted multiple of the second integer in response to a fifth subset of the encoded block.

In one embodiment, the plurality of encoded blocks correspond to a number in a double-base numbering system. The double-base numbering system may use Booth encoding. In some embodiments, the double-base numbering system uses “something-minus-something” encoding. In addition, the encoding may use a window that is 6-bits wide 5-bits wide, or 4-bits wide. In some embodiments, the first multiple may be selected from the plurality of multiples of the second integer. In a further embodiment, the second multiple is selected from the plurality of multiples of the second integer. The partial results may also be selectively shifted in response to at least one of the width of the binary block and the position of the binary block.

In one embodiment, the multiples of the second integer include 1, 3, 5, and 7 times the second integer. Alternatively the multiples of the second integer may include 1, 3, 5, 7, 11, and 13 times the second integer. In still another embodiment, the multiples of the second integer include 1, 3, 5, 7, 11, and 119 times the second integer.

An apparatus is also presented. In one embodiment, the apparatus includes a splitter configured to convert a first integer into a plurality of binary blocks. The apparatus may also include an encoder coupled to the splitter, the encoder configured to encode the plurality of binary blocks into a plurality of encoded blocks. In one embodiment, a processing module is configured to produce a plurality of multiples of a second integer. Additionally, the apparatus may include a partial results circuit coupled to the encoder and the processing module, the partial results circuit configured to produce a plurality partial results. A shifter may be coupled to the partial results block, the shifter may selectively shift the plurality of partial results to generate a plurality of shifted partial results. Also, an adder may be coupled to the shifter. The adder may add the plurality of partial results and the shifted partial results to create the product of a plurality of integers.

In a further embodiment, the partial results circuit may select a first multiple of the second integer in response to a first subset of the encoded block, select a second multiple of the second integer in response to a second subset of the encoded block, shift the first multiple of the second integer in response to a third subset of the encoded block, shift the second multiple of the second integer in response to a fourth subset of the encoded block, and selectively add or subtract the first shifted multiple of the second integer and the second shifted multiple of the second integer in response to a fifth subset of the encoded block. In a further embodiment, the partial results circuit is further configured to selectively shift in response to at least one of the width of the binary block and the position of the binary block.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of an apparatus according to the present embodiments.

FIG. 2 is a schematic block diagram illustrating another embodiment of an apparatus according to the present embodiments.

FIG. 3 is a schematic flow-chart diagram illustrating one embodiment of a method for multiplying integers in a processor according to the present embodiments.

FIG. 4 is a schematic flow-chart diagram illustrating one embodiment of a method for producing the partial results.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system. Alan Freedman, “The Computer Glossary” 268 (8th ed. 1998). A module comprises a machine or machines executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays (“FPGA”), programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In multiplication, if one of the operands is a constant, it is possible to perform optimizations for the series of additions or subtractions required to perform the multiplication.
Theorem 1 [9]: Multiplication by a k-bit constant requires

$$O ( \frac{k}{log k} )$$

additions/subtractions in the worst case.

In 1996 Pinch [10] proved that one can implement the multiplication by a k-bit number by using

$$O ( \frac{k}{{( log k )}^{α}} )$$

where, α<1, additions/subtractions.

The above two results are based on the idea of eliminating common subexpressions as much as possible in the signed-digit representation of the constant and re-use as much as possible any intermediate results obtained.

However, the condition α<1 in Pinch's theorem is not necessary and, in fact, multiplication by any k-bit constant can be achieved by using

$$O ( \frac{k}{log k} )$$

additions and shifts.
Theorem 2 [11]: Multiplication by a k-bit constant needs no more than

$$O ( \frac{k}{log k} )$$

additions in the worst case.

The fact that multiplication by a k-bit constant can be done in

$$O ( \frac{k}{log k} )$$

additions and one addition require O(k) elementary bit operation suggest that perhaps it would be possible to design and algorithm with asymptotic complexity

$$O ( \frac{{k}^{2}}{log k} )$$

elementary bit operations, which is o(k²). The constant multiplication algorithms suggested in [11] have two very attractive features: first, their complexity estimate has a very small implicit constant and, second, the conversion of the constant may be done very quickly.

### Double-Based Numbering System

The theorem that one can use only

$$O ( \frac{k}{log k} )$$

additions in implementing the multiplication by any k-bit number is based on a specific double-base representation of the constant.

Definition 1 (s-integer) [12]: Given a set of primes, an S-integer is a positive integer whose prime factors all belong to S.

Definition 2 (double-base number system) [12]: Given p, q, two different prime numbers, the double-base number system (DBNS) is a representation scheme in which every positive integer n is represented as the sum or difference of {p, q}-integers, i.e.:

$$n = {\sum }_{i = 1}^{l} {s}_{i} {p}^{{a}_{i}} {q}^{{b}_{i}} with {s}_{i} ∈ \{ - 1 , 1 \} and {a}_{i} , {b}_{i} \geq 1 \qquad ( 1 )$$

The size, or length, of a DBNS expansion is equal to the number of terms, l, in Eqn. 1. Most applications of DBNS use the set of bases {2, 3}.

This representation is highly redundant regardless of whether one considers signed (sᵢ=±1), or unsigned (sᵢ=1) expansions. For instance, assuming only unsigned double-base representations, one can show that 10 has exactly five different DBNS representations, 100 has exactly 402 different DBNS representations, 1000 has exactly 1,295,579 different DBNS representations, etc. The number of different unsigned DBNS representation satisfies a nice recursive formula:

$$\begin{matrix}f ( n ) = f ( n - 1 ) + f ( \frac{n}{3} ) & if n = ( mod 3 ) , \\ = f ( n - 1 ) & otherwise .\end{matrix}$$

There are several possible proofs of this formula [12].

The above formula shows that there exist many ways to represent a given integer in DBNS. Some of these representations are of special interest, most notably, the ones that require the minimal number of {2, 3}-integers; that is, an integer can be represented as the sum of l terms, but cannot be represented with (l−1) or fewer. These so called canonic representations are extremely sparse. An easy way to visualize numbers in DBNS is to use a two-dimensional array (the columns represent the powers of 2 and the rows represent the powers of 3) into which each non-zero cell contains the sign of the corresponding term. For example, 127 has exactly six canonic representations. Two of them are shown in Tables 1 and 2.

TABLE 1
A canonic representation of 127 obtained by
the Greedy Algorithm

| | 1 | 2 | 4 |
|---|---|---|---|
| 1 | 1 | | |
| 3 | | | |
| 9 | | 1 | |
| 27 | | | 1 |

127 = 2²3³ + 2¹3² + 2⁰3⁰ = 108 + 18 + 1

TABLE 2
Different canonic representation of 127

| | 1 | 2 | 4 | 8 | 16 | 32 | 64 |
|---|---|---|---|---|---|---|---|
| 1 | | | | | | | 1 |
| 3 | | | | | | | |
| 9 | | | 1 | | | | |
| 27 | 1 | | | | | | |

127 = 2⁶3⁰ + 2²3² + 2⁰3³ = 64 + 36 + 27

Some numerical facts provide a good impression about the sparseness of the DBNS. The smallest positive integers requiring m {2, 3}-integers in its unsigned canonic DBNS representation are shown in Table 3. For instance, the table shows that the smallest integer requiring five {2, 3}-integers in its unsigned canonic DBNS representation is 18,431. Some of these numbers may be used to prove very non-trivial upper bounds for the number of additions sufficient to multiply by any k-bit number. All of the numbers in Table 3 can be found, at least in principle, by using exhaustive search.

TABLE 3
Facts about the canonic unsigned DBNS representations

| | The smallest positive integer requiring m |
|---|---|
| | {2, 3}-integer in its canonic unsigned DBNS |
| m | representation |
| 1 | 1 |
| 2 | 5 |
| 3 | 23 |
| 4 | 431 |
| 5 | 18,431 |
| 6 | 3,778,433 |
| 7 | 1,441,896,119 |

If one considers signed representations, then the theoretical difficulties in establishing the properties of this number system drastically increase. Specifically, it is possible to prove that the smallest number that can be represented as the sum or difference of two {2, 3}-integers is 103. By using the Erdos-Pomerance-Schmudtz theorem about the low bounds of the Carmichael function λ, it is possible to prove that the next smallest number requiring m {2, 3}-integers in their canonic signed DBNS representations are 4,985,641,687, and 326,552,783.

Finding the canonic DBNS representations in a reasonable amount of time, especially for large integers (e.g. cryptographic size numbers), seems to be a very difficult task. Fortunately, one can use a greedy approach to find a fairly sparse representation very quickly. Given n>0, Algorithm 1 below returns a signed DBNS representation for n. Sometimes the greedy algorithm fails in finding a canonic representation. The smallest example is 41; the canonic representation is 32+9, whereas the greedy algorithm returns 41=36+4+1.

Algorithm 1 Greedy algorithm

Input: An integer n > 0
Output: The sequence of triples
(sᵢ,aᵢ,bᵢ)_{(i≧0)} such that n = Σᵢsᵢ2^{a}^{ᵢ}3^{b}^{ᵢ} with sᵢ ε{−1,1} and aᵢbᵢ ≧ 0
1: s ← 1;
2: while n ≠ 0 do
3: Find the best approximation of n of the form z = 2^{a}3^{b};
4: print (s,a,b);
5: if n < z then
6: s ← −s;
7: end if
8: n ←|n − z|;
9: end while

The most important feature of the greedy algorithm is that it guarantees an expansion of sublinear length:
Theorem 3 [14]: Algorithm 1 terminates after

$$k ∈ O ( \frac{log n}{log log n} )$$

steps.

The key point in proving this theorem is the following result by Tijdeman [15]:
Theorem 4 [15]: Let x and y be two consecutive {2, 3}-integers, x>y. Then there exist effectively computable constants, c₁ and c₂, such that

$$\frac{x}{{( log x )}^{{c}_{1}}} < x - y < \frac{x}{{( log x )}^{{c}_{2}}} .$$

The last theorem provides a very accurate description of the difference between two consecutive {2, 3}-integers. More to the point, it can be generalized to any set of {p₁, p₂, . . . , pₛ} if pₛ is fixed. The proof depends on the main result of Baker from the theory of linear form in logarithms [16]:
Theorem 5 [16]: Let a₁, a₂, . . . , aᵣ be nonzero algebraic integers and b₁, b₂, . . . , bᵣ rational numbers. Assume Πᵢ₌₁^{r}aᵢ^{b}^{ᵢ}≠1 and B=max(b₁, b₂, . . . , bᵣ). Then the following inequality holds:

$$\vert {\sum }_{r = 1}^{r} {a}_{i}^{{b}_{i}} - 1 \vert \geq exp ( - C ( r ) log {a}_{2} … log {a}_{r} )$$

The constant, C (r), is huge, even in the case of linear forms in two logarithms, approximately exp(6×10⁹). By using some results aimed specifically at the case of two logarithms [17] one can reduce C (r) to exp(10⁷), but this is still enormous. However, practical simulations suggest that this constant is much smaller, perhaps within a single digit.

If one applied the greedy algorithm without any modifications, the largest powers of 3 that might occur in the DBNS representation of n is log₃ n=O(log n). If one encodes the integers in the way shown in Tables 1 and 2, then one will need rather large tables, which could be a drawback in many applications. The following theorem shows that even if one uses very few powers of three, one can still achieve a DBNS representation of n having sublinear length.
Theorem 6: Every positive integer, n, can be represented as the sum of at most

$$O ( \frac{log n}{log log n} )$$

{2, 3}-integers such that the largest power of three is bounded by

$$O ( \frac{log n}{log log n} ) .$$

Proof: Consider the binary representation of n. It contains log n bits. Next one can break down this representation into log log n blocks of bits, each of length

$$O ( \frac{log n}{log log n} ) .$$

According to Theorem 2, every block can be represented as the sum of at most

$$\begin{matrix}O ( \frac{\frac{log n}{log log n}}{log ( \frac{log n}{log log n} )} ) = O ( \frac{log n}{{log}^{2} log n - log log n log log log n} ) \\ = O ( \frac{log n}{{log}^{2} log n} )\end{matrix}$$

{2, 3}-integers. As the number of blocks is log log n, this representation consists of at most

$$O ( \frac{log n}{log log n} )$$

{2, 3}-integers. The highest power of three that occurs in such a representation is governed by the highest power of three that can occur in every block and it is at most

$$O ( \frac{log n}{log log n} ) .$$

Theorem 2 is constructive and leads to the following simple algorithm for computing DBNS representation of length

$$O ( \frac{log n}{log log n} )$$

with restricted powers of three.

The Theorem 6 and Algorithm 1 are the key ingredients in proving Theorem 2, that is, the fact that multiplication by a k-bit constant needs no more than

$$O ( \frac{k}{log k} )$$

additions in the worst case. If one uses the standard binary expansion of a k-bit constant, then the number of additions is one less than the Hamming weight of the constant, that is, O(k) if one uses standard binary or signed-digit representation of the constant. However, if the constant is represented in DBNS format, then the number of additions will be equal to the number of {2, 3}-integers necessary to represent this constant plus the highest power of three that occurs in the corresponding DBNS representation (because the multiplication by three needs one shift and one addition). According to Theorem 6, if one restricts the highest power of three to

$$O ( \frac{k}{log k} )$$

it is still sufficient to guarantee that the DBNS expansion, found by the blocking algorithm will be of length

$$O ( \frac{k}{log k} )$$

. Therefore, the total number of additions will be bounded from above by

$$O ( \frac{k}{log k} ) .$$

The example provided below demonstrates some of the above results:

### Example 1

### Show that the Multiplication by any 300-Bit Constant can be Achieved by Using at Most 77 Additions

One may consider the binary representation of a 300-bit number and break this representation into ten 30-bit blocks. According to Table 3, every 30-bit integer can be represented by using at most six {2, 3}-integers (because 2³⁰<1,441,896,119<2³¹. Since 31⁸<2³⁰<3¹⁹, the execution of Algorithm 2 will return a DBNS expansion of any 300-bit number of length at most 10 (the number of 30-bit blocks)×6 (the maximal number of {2, 3}-integers per block)=60. The highest power of three that might occur in this expansion is 18; therefore, in the worst case one will need 60+18−1=77 additions.

Algorithm 2 Blocking algorithm for computing DBNS expansion of n

```
Input: A positive integer, n, block size w, precomputed canonic
    $representations of every integer {\sum }_{i = 0}^{w - 1} = {d}_{i} {2}^{i} , {d}_{i} ∈ \{ 0 , 1 \}$
Output: List, L , of {2, 3}-integers representing the DBNS expansion of it
    $with powers of three restricted by O ( \frac{log n}{log log n} )$
1: L = {}
$2 \text{:} for j = 0 to ⌈ \frac{k}{w} ⌉ do$
3: {Process block of length w};
4: Find canonic DBSN representation of
${\sum }_{i = 0}^{w - 1} {d}_{i + jw} {2}^{i} from the precomputed table ;$
5: Multiply each term of the expansion by 2^{jw} and add to L;
6: end for
```

It is interesting to note that none of the available methods on constant multiplication leads to such concrete, easy-to-understand and interpret, and non-trivial bounds. The above example with the 300-bit numbers deserves a few comments. It is clear that the selected block size, 30 bits, would have been too large, especially, for hardware implementation. But even if one uses much smaller blocks, such as 12-bit blocks—a completely appropriate size from both software and hardware point of view—the estimate that can be found is still useful. In the worst case one will need 25×4 (all 12-bit numbers can be represented by using at most four terms; see Table 3) plus seven (the highest possible power of three) minus one, that is, 106. In this case one can appreciate the savings that can be achieved if one were to allow subtractions. Up to 4984 one can represent any number as the sum or difference of at most three {2, 3}-integers. Therefore, if one can use subtractions, the algorithm with small 12-bit blocks will require in the worst case 25×3+7−1=81 additions/subtractions. If one inspects all the canonic representations up to 4095, one will see that the highest power of two that occurs is only 12; therefore, the risk of overflow is completely acceptable.

Multiplication Algorithm with Sub-Quadratic Complexity Based on Double-Base Numbering System

From the previous section it should be clear that once one of the multiplicands (k-bit integers) has been converted into DBNS format with restricted power of three, the final part of the multiplication algorithm will require

$$O ( \frac{{k}^{2}}{log k} )$$

elementary bit operations. So, the only thing that remains to be analyzed is the cost of conversion.

For the conversion task on has essentially two options: First, one can consider the look-up table based approach. It requires the search over each of the precomputed O(log k) blocks, each block corresponding to a number of size

$$O ( \frac{k}{log k} ) .$$

The entire task will require O(log² k) elementary bit operations, so the overall complexity will be

$$O ( \frac{{k}^{2}}{log k} + {log}^{2} k ) = O ( \frac{{k}^{2}}{log k} ) .$$

Second, one has to consider the transformation of the multiplicand on the fly by using some memory-free algorithm with low computational complexity. The algorithm proposed by Berthé and Imbert allows a very fast implementation of Step 3 of the greedy algorithm [31]. For a k-bit integer it computes the closest {2, 3} integer in O(log k) operations, each involving O(k) elementary bit operations. If this algorithm is used, then one will need O(k log k) elementary bit operations to convert the entire multiplicand into the desired DBNS format. Therefore, the total bit-complexity of the multiplication procedure would remain

$$O ( \frac{{k}^{2}}{log k} ) .$$

This can be encapsulated as:
Theorem 7: The DBNS multiplication algorithm requires

$$O ( \frac{{k}^{2}}{log k} )$$

elementary bit operations.

There are several other sub-quadratic multiplication algorithms that have a superior asymptotic behavior compared to the multiplication methods and apparatus described here. However, they all suffer from the fact that the implicit constant, associated with their complexity analysis is very large. This drawback severely limits their practical applicability.

The constant hidden in the

$$O ( \frac{{k}^{2}}{log k} )$$

estimate of the disclosed algorithm depends entirely on the constant associated with the complexity of the greedy algorithm (Theorem 2). That is, for a given k-bit number, one anticipates

$$C \frac{k}{log k}$$

{2, 3}-integers in its DBNS representation. Regarding constant C, there is a big gap between computational experiments and what the best available theory can rigorously and unconditionally prove. The only thing that the theory can guarantee is that this constant is less than log(C (r)), where C (r) is the constant in the Baker's theorem. That would mean that one can only prove that C is less than 10⁷. The computational experiments strongly suggest that C is very close to one and, under certain reasonable probabilistic assumptions, it would be one. That being the case, the constant C in a DBNS multiplication algorithm can be evaluated as 2. This is much smaller than the constants associated with the complexity analysis of the other sub-quadratic multiplication algorithms and points out that for medium sized integers the disclosed methods and apparatus have a clear potential to outperform all of the existing ones, including methods and apparatus that use shift-and-add algorithms.

A key point of the disclosed methods and apparatus is the expression of one of the multiplicands in DBNS format with a restricted highest power of three. The following example explains the encoding scheme in a pictorial way:

### Example 2

### Representation of the Multiplicands in the DBNS Format

Representation of 10,601 into DBNS format with highest possible power of three and using two 7-bit blocks is shown in the Table 4.

TABLE 4
A DBNS representation of 10601₁₀ = 10100101101001₂ = 82 × 2⁷ + 105
by using the blocking algorithm with two blocks of length
7 bits and highest power of three equal to two

| | 2⁰ | 2¹ | 2² | 2³ | 2⁴ | 2⁵ | 2⁶ | 2⁷ | 2⁸ | 2⁹ | 2¹⁰ | 2¹¹ | 2¹² | 2¹³ |
|---|---|---|---|---|---|---|---|---|---|---|---|---|---|---|
| 3⁰ | 1 | | | 1 | | | | | | | | | | 1 |
| 3¹ | | | | | | 1 | | | | | | | | |
| 3² | | | | | | | | | 1 | | | | | |

| | |
|---|---|
| 105 | 82 |

### Multiplier Structure

The improved asymptotic complexity of the DBNS-based multiplication algorithm guarantees that, eventually, it will outperform the shift-and-add based algorithms for certain range of multiplicands. Two practical problems are: a) when will it happen and b) how to apply the algorithm as efficiently as possible on hardware.

One point of the disclosed methods and apparatus is to substitute the multiplication of B (the second multiplicand) by A into a succession of multiplications by several very sparse binary numbers—the rows of the DBNS matrix—and multiplications by some small number of powers of three.

There are several parameters of the algorithm that has to be selected with extreme care. The first one is the window size, w. Some embodiments use a look-up table (LUT) approach for the conversion, so from a hardware view point it is desirable to use not-too-big LUTs. In principle, the larger the LUTs are, the fewer additions/subtractions required. However, computational experiments show that when the LUT sizes grow to a certain point, the number of additions/subtractions does not significantly further decrease, while simultaneously the area complexity of the LUT grows exponentially.

The VLSI complexity theory [41] suggests that one should try to minimize the AT²-complexity measure, where A is the area complexity of the design and T is the time complexity. Modern VLSI designs usually neglect this figure of merit and emphasizes issues such as reduction of the power consumption, reduction of the critical path, etc. The time complexity of the multiplication problem, however, is still unsolved. In the case of area-time complexity, the situation is even more unclear, however, there are some results that provide certain non-trivial lower bounds.
Theorem 8 [42]: For VLSI circuits that compute the middle bit of multiplication of two n-bit integers, the area-time complexity satisfies the following lower bound: AT²=Ω(n²).

The following is a general description of the proposed multipliers. Let A and B be two k-bit unsigned integers, i.e., A,B ε[0,2^{k-1}] and let C denote the 2k-bit result of the multiplication C=A×B. In some embodiments, the disclosed multipliers compute the entire product in parallel combinatorially, i.e., without registers or feedback loops. In some embodiments, digit-serial multipliers based on the teachings herein are used.

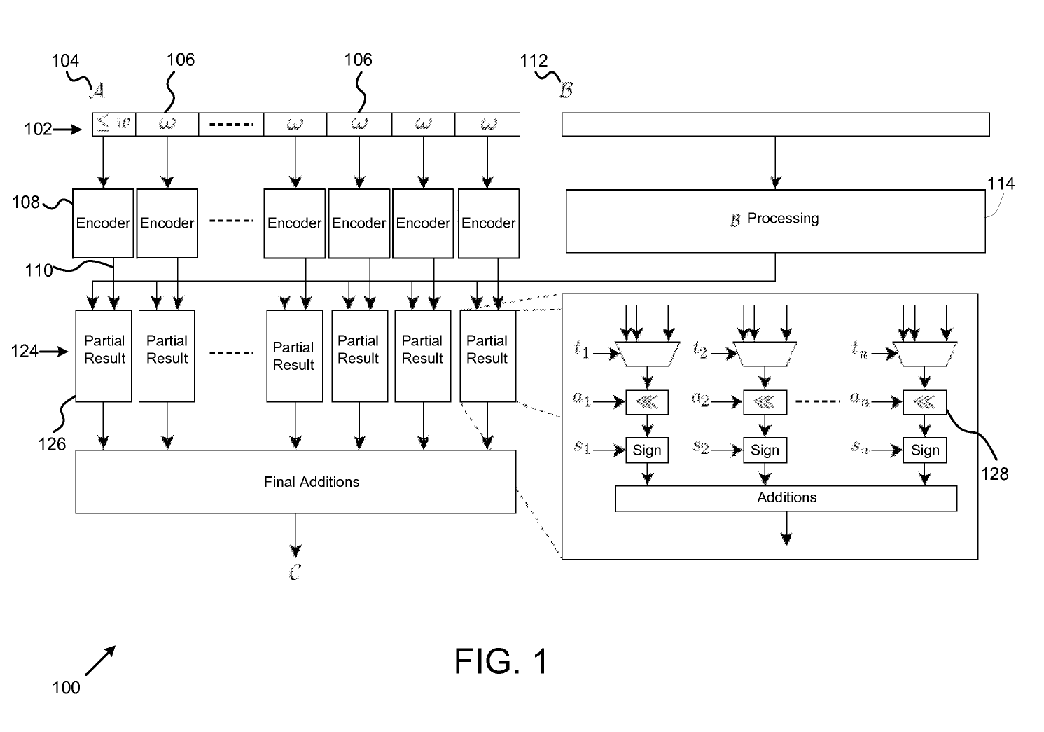

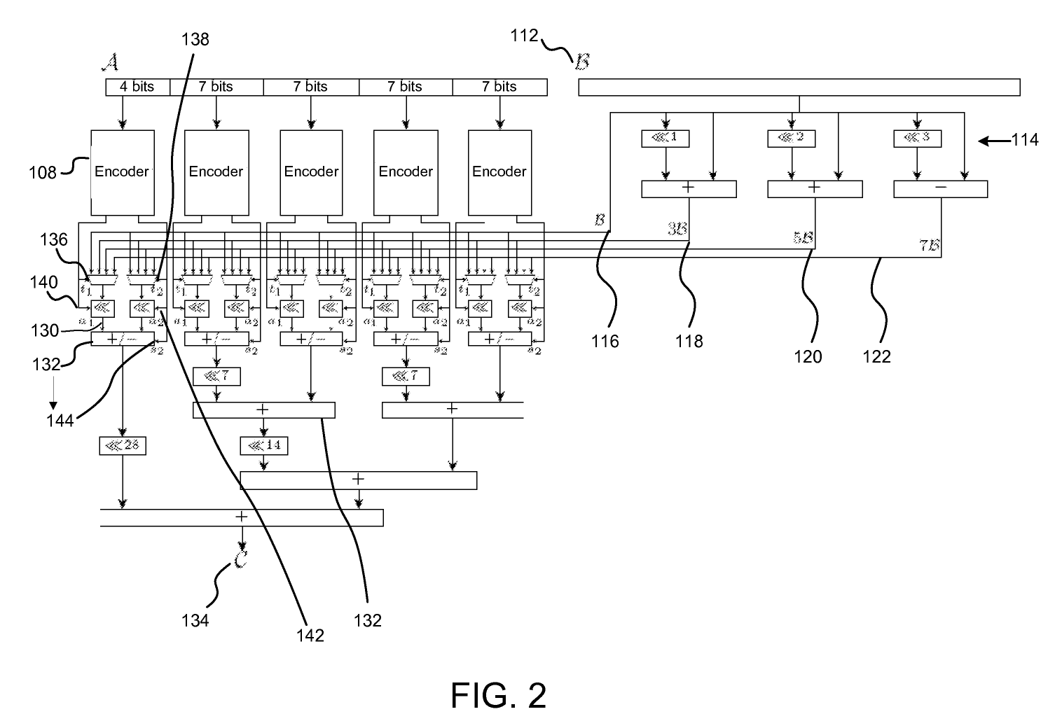

FIGS. 1 and 2 illustrate one embodiment of an apparatus 100 for multiplying integers 104 and 112. In a particular embodiment, the apparatus may include a splitter 102 configured to convert a first integer 104 into a plurality of binary blocks 106. The apparatus 100 may also include an encoder 108 coupled to the splitter 102, where the encoder 108 is configured to encode the plurality of binary blocks 106 into a plurality of encoded blocks 110. In one embodiment, a processing module 114 is configured to produce a plurality of multiples 116, 118, 120, 122 (shown in FIG. 2) of a second integer 112. Additionally, the apparatus 100 may include a partial results circuit 124 coupled to the encoder 108 and the processing module 114, the partial results circuit 124 configured to produce a plurality partial results 126. A shifter 128 may be coupled to the partial results circuit 124, the shifter 128 may selectively shift the plurality of partial results 126 to generate a plurality of shifted partial results 130. Also, an adder 132 may be coupled to the shifter 128. The adder 132 may add the plurality of partial results 126 and the shifted partial results 130 to create the product 134 of a plurality of integers, 104 and 112.

In a further embodiment, the partial results circuit 124 may select a first multiple 116 of the second integer 112 in response to a first subset 136 of the encoded block 110, select a second multiple 118 of the second integer in response to a second subset 138 of the encoded block 110, shift the first multiple 116 of the second integer in response to a third subset 140 of the encoded block, shift the second multiple 118 of the second integer in response to a fourth subset 142 of the encoded block, and selectively add or subtract the first shifted multiple of the second integer and the second shifted multiple of the second integer in response to a fifth subset 144 of the encoded block. In a further embodiment, the partial results circuit 124 is further configured to selectively shift in response to at least one of the width of the binary block 106 and the position of the binary block 106.

In one embodiment, these various components of the apparatus may be implemented in hardware, including analogue and/or digital circuitry. Alternatively, the components may be implemented in an FPGA configured to operate firmware instructions.

The general structure of all multipliers that will be proposed in this report is depicted in FIG. 1. A is split using w-bit windows into ┌k/w┐ blocks. Each w-bit block, Aᵢ is fed into an encoder. It encodes a block, i.e., an integer in the interval [0, 2^{w-1}], as the following sum of n terms:

(−1)^{s}^{₁}2^{a}^{₁}3^{t}^{₁}+(−1)^{s}^{₂}2^{a}^{₂}3^{t}^{₂}+ . . . +(−1)^{s}^{ₙ}2^{a}^{ₙ}3^{t}^{ₙ} (2)

where aᵢ ε[0, w], sᵢ ε{0,1}, and tᵢ ε[0, m] where m is the predefined highest power of three allowed by the representation. The encoder is essentially a table with 2 rows (one for each integer represented by the block), each containing n triples of the form (sᵢ, aᵢ, tᵢ).

The operand B is fed into a circuit that computes Bᵢ=3^{t}^{ᵢ}B for i=0, . . . , m. These computations are carried out with shifts, additions, and subtractions. Each partial result circuit computes Eqn. 2 by, first, selecting the correct Bᵢ from the values computed in the B processing. They are, then, shifted by aᵢ bit positions to the left (multiplication by 2^{a}^{ᵢ}), and, finally, added or subtracted as described by the sign bits, sᵢ, to receive the partial result Aᵢ×B. The result of the entire multiplication, C=A×B, is computed by shifting and adding the partial results.

One advantage of the DBNS multiplier is the fact that it may have sub-quadratic complexity. Therefore, it suffices to implement the algorithm for relatively small numbers and, then, approximate the break-even point with the reference multipliers by using the known complexity estimates for the two algorithms: binary-based and DBNS-based.

An alternative way to write the double-base number representation obtained by the blocking algorithm is given by the following formula:

$$A = {\sum }_{i = 0}^{m} {3}^{i} ( {\sum }_{j = 1}^{c ( i )} {s}_{i}^{( j )} {2}^{{b}_{i}^{( j )}} ) \qquad ( 3 )$$

where m is the maximal power of three used; c(i) is the number of binary exponents that has to be multiplied by 3ⁱ, 0≦i≦m; bᵢ^{(j)} is the j-th binary exponent that corresponds to 3ⁱ, 1≦j≦c; c(i) sᵢ^{(j)}=±1 gives the sign of the term 2^{b}^{ᵢ}^{(f)}.

### Example 3

### 10601 Represented with Eqn. 3

m=2—the highest power of 3 used;
c(0)=3—the number of nonzero terms on the first row of the DBNS matrix (see Table 4);
b₀⁽¹⁾=0, b₀⁽²⁾=3, b₀⁽³⁾=13—the exponents of the two that are used on the first row of the DBNS matrix;
s₀⁽¹⁾=−1, s₀⁽²⁾=1, s₀⁽³⁾=1—the sign of the powers of two used on the first of the DBNS matrix;
c(1)=1—the number of nonzero terms on the second row of the DBNS matrix (see Table 4);
b₁⁽¹⁾5—the exponents of the two that are used on the second row of the DBNS matrix;
s₁⁽¹⁾=1—the sign of the powers of two used on the second row of the DBNS matrix;
c(2)=1—the number of nonzero terms on the third row of the DBNS matrix (see Table 4);
b₂⁽¹⁾=8—the exponents of the two that are used on the third row of the DBNS matrix;
s₂⁽¹⁾=1—the sign of the powers of two used on the third row of the DBNS matrix;

The fact that different rows may (and usually do) require different number of terms greatly complicates the design and contributes a lot to the time and, especially, to the area complexity. So, certain modifications of the encoding scheme have to be made to simplify the design, without affecting one important advantage: the asymptotic superiority over the binary multiplication.

It is possible to generalize the above formula and consider the representation of A like this:

$$A = {\sum }_{i = 0}^{m} {d}_{i} ( {\sum }_{j = 1}^{c ( i )} {s}_{i}^{( j )} {2}^{{b}_{i}^{( j )}} ) \qquad ( 4 )$$

That is, one can apply the same idea, while multiplying the elements of every row by suitably chosen integers, dᵢ. What is meant by ‘suitably chosen’ is numbers that are specifically selected as to optimize the performance of the multiplier for a particular window size, w. It is clear that if dᵢ=3ⁱ then one has the representation outlined in Eqn. 3.

This new degree of freedom associated with the more unrestricted choice of the digits has particular importance. For example, if one uses a window of size 7, then one has to make sure than any integer between 0 and 127 can be represented by using the corresponding number representation (Eqn. 3 or 4). But if one wants to use the double-base number representation in Eqn. 3, then one will have to use three terms because certain numbers less than 127 cannot be represented as the sum or difference of two {2, 3}-integers (as pointed it above, the smallest positive integer with this property is 103). On the other hand, if one uses representation in the form of Eqn. 4, then it is sufficient to use digits dᵢ={1, 3, 5, 7} which guarantee a representation for every 7-bit integer in the form Eqn. 4 by using at most two terms. The following fact may be used in the design of some of the disclosed methods and apparatus:

Fact: Every non-negative 7-bit integer can be represented in the form

z₁±z₂, where z₁, z₂ ε{1·2^{k}, 3·2^{k}, 5·2^{k}, 7·2^{k}, k={0, 1, . . . 7}
Note: The smallest number for which the above fact is not valid is 137, i.e., an 8-bit number.

So, from a point of view of integer representations, this new number representation may be more attractive compared to DBNS. In order to cover the same range (7-bit numbers) with the DBNS one must use the digit set {1, 3, 9, 27, 81} as shown in Table 3.

Selection of what kind of an encoding is used determines the construction of the rest of the multiplier. The following examples demonstrate the effects and tradeoffs of parameter selection. For example, using a window size 7 one can encode every 7-bit number as in Table 5.

TABLE 5
Encoding scheme for 7-bit numbers. The entire encoding table is
given in Table 6 as used for coders of the multiplier in FIG. 2

| | Digit | Binary | Digit | | Binary |
|---|---|---|---|---|---|
| | selection | exponent | selection | Sign | exponent |
| A (a 7-bit | 2 bits | 3 bits | 2 bits | 1 bit | 3 bits |
| number) | | | | | |

The encoding scheme shown in Table 5 is very compact; it represents every 7 bit number by an 11-bit block of well-structured data. If one uses signed-digit representations, then one has to substitute the 7-bit numbers with a 14-bit succession of zeros and ones, due to the necessity to use 2 bits per digit in the binary number system with digits 0, 1 and −1. Also, only one sign bit is required, because the first number, z₁, is positive by default. Thirdly, every 7-bit number has exactly two terms, which greatly reduces the number of multiplexers and does not negatively affect the length of the critical path. The entire table of encoding is shown in Table 6.

TABLE 6
The entire 7-bit look-up table

| | | | | | | | |
|---|---|---|---|---|---|---|---|
| 0 | 00 000 00 0 000 | 1 | 00 001 00 0 000 | 2 | 00 000 00 1 000 | 3 | 00 000 00 1 001 |
| 4 | 00 001 00 1 001 | 5 | 00 000 00 1 010 | 6 | 00 001 00 1 010 | 7 | 00 011 00 0 000 |
| 8 | 00 010 00 1 010 | 9 | 00 000 00 1 011 | 10 | 00 001 00 1 011 | 11 | 00 011 01 1 000 |
| 12 | 00 010 00 1 011 | 13 | 00 000 01 1 010 | 14 | 00 100 00 0 001 | 15 | 00 100 00 0 000 |
| 16 | 00 011 00 1 011 | 17 | 00 000 00 1 100 | 18 | 00 001 00 1 100 | 19 | 00 100 011 000 |
| 20 | 00 010 00 1 100 | 21 | 00 000 10 1 010 | 22 | 00 100 01 1 001 | 23 | 00 100 111 000 |
| 24 | 00 011 00 1 100 | 25 | 00 000 01 1 011 | 26 | 00 001 01 1 011 | 27 | 00 101 10 0 000 |
| 28 | 00 101 00 0 010 | 29 | 00 101 01 0 000 | 30 | 00 101 00 0 001 | 31 | 00 101 00 0 000 |
| 32 | 00 100 00 1 100 | 33 | 00 000 00 1 101 | 34 | 00 001 00 1 101 | 35 | 00 101 011 000 |
| 36 | 00 010 00 1 101 | 37 | 00 101 10 1 000 | 38 | 00 101 011 001 | 39 | 00 101 11 1 000 |
| 40 | 00 011 00 1 101 | 41 | 00 000 10 1 011 | 42 | 00 001 10 1 011 | 43 | 01 000 10 1 011 |
| 44 | 00 101 01 1 010 | 45 | 01 100 01 0 000 | 46 | 00 101 11 1 001 | 47 | 01 100 00 0 000 |
| 48 | 00 100 00 1 101 | 49 | 00 000 01 1 100 | 50 | 00 001 01 1 100 | 51 | 01 000 01 1 100 |
| 52 | 00 010 01 1 100 | 53 | 01 100 10 1 000 | 52 | 00 110 10 0 001 | 53 | 01 100 11 1 000 |
| 56 | 00 110 00 0 011 | 57 | 00 000 11 1 011 | 58 | 00 110 01 0 001 | 59 | 00 110 10 0 000 |
| 60 | 00 110 00 0 010 | 61 | 00 110 01 0 000 | 62 | 00 110 00 0 001 | 63 | 00 110 00 0 000 |
| 64 | 00 101 00 1 101 | 65 | 00 000 00 1 110 | 66 | 00 001 00 1 110 | 67 | 00 110 011 000 |
| 68 | 00 010 00 1 110 | 69 | 00 110 10 1 000 | 70 | 00 110 011 001 | 71 | 00 110 111 000 |
| 72 | 00 011 00 1 110 | 73 | 10 100 11 0 000 | 74 | 00 110 10 1 001 | 75 | 10 100 10 0 000 |
| 76 | 00 110 01 1 010 | 77 | 10 100 01 0 000 | 78 | 00 110 11 1 001 | 79 | 10 100 00 0 000 |
| 80 | 00 100 00 1 110 | 81 | 00 000 10 1 100 | 82 | 00 001 10 1 100 | 83 | 01 000 10 1100 |
| 84 | 00 010 10 1 100 | 85 | 10 000 10 1 100 | 86 | 01 001 10 1 100 | 87 | 10 100 111 000 |
| 88 | 00 110 01 1 011 | 89 | 01 101 11 0 000 | 90 | 01101 01 0 001 | 91 | 01101 10 0 000 |
| 92 | 00 110 11 1 010 | 93 | 01 101 01 0 000 | 94 | 01 101 00 0 001 | 95 | 01 101 00 0 000 |
| 96 | 00 101 00 1 110 | 97 | 00 000 01 1 101 | 98 | 00 001 011 101 | 99 | 01 000 01 1 101 |
| 100 | 00 010 01 1 101 | 101 | 01 101 10 1 000 | 102 | 01 001 01 1 101 | 103 | 01 101 11 1 000 |
| 104 | 00 011 01 1 101 | 105 | 11 100 11 0 000 | 106 | 01 101 10 1 001 | 107 | 11 100 10 0 000 |
| 108 | 00 111 10 0 010 | 109 | 11 100 01 0 000 | 110 | 01 101 111 001 | 111 | 11 100 00 0 000 |
| 112 | 00 111 00 0 100 | 113 | 00 000 11 1 100 | 114 | 00 001 11 1 100 | 115 | 01 000 11 1 100 |
| 116 | 00 111 01 0 010 | 117 | 10 000 11 1 100 | 118 | 00 111 10 0 001 | 119 | 11 000 11 1 100 |
| 120 | 00 111 00 0 011 | 121 | 00 111 11 0 000 | 122 | 00 111 01 0 001 | 123 | 00 111 10 0 000 |
| 124 | 00 111 00 0 010 | 125 | 00 111 01 0 000 | 126 | 00 111 00 0 001 | 127 | 00 111 00 0 000 |

### Example 4

### Encoding of Number 89

From Table 6 one can see that 89 is encoded as 01 101 11 0 000. The five blocks of bits—01, 101, 11, 0, and 000—have the following meaning. The first two blocks encode the first term, z₁, and the remaining three blocks encode the second term, z₂. The first block, 01, shows that 3 is selected (the second digit from the set {1, 3, 5, 7}) and the second block, 101, gives the power of two: 2¹⁰¹^{₂}=32. As a result, the first term becomes: 3×32=96. The third block, 11, shows that 7 is selected (the fourth digit in {1, 3, 5, 7}). The fourth block, 0, gives the sign of the second term which in this case is minus. The fifth block, 000, gives the power of two 2⁰⁰⁰^{₂}=1. Hence, the second term is −7×1=−7. Therefore, 89 is represented as 96−7=3×2⁵−7=2⁰.

If one prefers to work with a matrix representation of numbers, then the following DBNS-like representation given in the Table 7 would be useful. This representation uses exactly one term from the first four rows and exactly one term from the following four rows.

TABLE 7
Representation of 89 with the 7-bit encoding

| | 2⁰ | 2¹ | . . . | 2⁵ |
|---|---|---|---|---|
| 1 | 0 | 0 | 0 | 0 |
| 3 | 0 | 0 | 0 | 1 |
| 5 | 0 | 0 | 0 | 0 |
| 7 | 0 | 0 | 0 | 0 |
| 1 | 0 | 0 | 0 | 0 |
| 3 | 0 | 0 | 0 | 0 |
| 5 | 0 | 0 | 0 | 0 |
| 7 | −1 | 0 | 0 | 0 |

The following example shows how a very efficient 32×32-bit multiplier can be produced by combining this new 7-bit representation with the general multiplier structure depicted in FIG. 1.

### Example 5

### 32-Bit Multiplier using a 7-Bit Encoding

The entire architecture of a 32×32 bit multiplier is pictorially demonstrated in FIG. 2. The chosen window size is w=7. The multiplicand, B, is multiplied by 3, 5, and 7. The multiplicand A is segmented into five blocks, the first four of length 7, the last one of length 4. These five blocks are encoded by using the scheme of Table 6. Correct multiples of B are selected with the multiplexers using tᵢ as the selectors and shifted by aᵢ in the barrel shifters. A partial result is received either with an addition or a subtraction depending on the value of s₂. Finally, the product is obtained by using a binary-tree summation of depth 3 that requires 4 additions. Clearly, the total number of adders and subtractors in the multiplier is only 12.

Now one can generalize this representation to a) more blocks and b) more flexible selection of digits. The reason why such a generalization is necessary is the following. With the selection of digits—1, 3, 5, 7—one can cover the whole 7-bit dynamic range. As mentioned, 137 cannot be represented as the sum or difference of two numbers belonging to the set {1×2^{k}, 3×2^{k}, 5×2^{k}, 7×2^{k}, k-nonegative integer}, therefore, one cannot straightforwardly extend this encoding to the 8-bit dynamic range. One will need either more summands or more digits, or both.

For multipliers it is optimal to have two summands (as in the above explained case with 7-bit numbers) and a carefully selected set of digits. This particular encoding can be formally expressed as follows:

A=±z₁±z₂ (5)

where z₁={a₁·2^{k}, a₂·2^{k}, . . . , aₛ·2^{k}}, z₂={b₁·2^{k}, b₂·2^{k}, . . . , b₁·2^{k}}, for k=0, 1, . . . , w. The determination of the sets of Dₐ={a₁, a₂, . . . , aₛ} and D_{b}={b₁, b₂, . . . , bₗ} is the cornerstone of the disclosed methods and apparatus. In the above example with 7-bit integers, the sets of digits were Dₐ=D_{b}={1, 3, 5, 7}. For a successful implementation of the multiplication, these sets have to satisfy many conditions. Some of these conditions include:
1) Mandatory: Every number between 0 and 2^{w}−1 must have a representation in the form of Eqn. 5.
2) Optional:
   a) The computation of the elements of the set U={a₁·B, a₂·B, . . . , aₛ·B, b₁·B, b₂·B, . . . , bₗ·B} should be achievable by using the minimal possible number of additions and subtractions;
   b) The critical path of the above computation should be as minimal as possible; ideally it should be one.
   c) The total number of additions/subtractions required in implementing the multiplication algorithm based on representation of the first multiplier in the form of Eqn. 5 is 2┌k/w┐+s+l−t−1, where t is the number of digits that appear in both sets, Dₐ and D_{b}. The number of additions/subtractions should be minimized as well.
   d) If it possible to select those digits in such a way as to encode every w-bit number in the form z (that is, the first summand is always positive), then it will lead to smaller area complexity of the design.
   e) If it is possible to fix the signs of the both summands, z₁ and z₂ (that is, if one represents every w-bit integer as either z₁+z₂ or z₁−z₂), then one can expect further hardware simplifications due to the elimination of the necessity to process the sign of the second summand.

To see how delicate the digit selection procedure is, one may consider the case of 8-bit windows applied to 64×64 bit multiplication. To ensure that condition 2a) is satisfied, it is clear that one should choose as many identical digits as possible. However, if one wants all the digits to be identical, that is, s=l and aᵢ=bᵢ for i=1, . . . , s, then the computational experiments shows that one will need at least 7 digits to guarantee a representation for every 8-bit number—the mandatory condition. In this case one will need at most 22 additions/subtractions to implement the 64×64-bit multiplication. However, 22 operations is not optimal.

The below provided solution, found via an extensive combinatorial search (more than 10 billion possible digits combinations have been analyzed) shows one example of an extremely non-trivial digit selection.

Fact: Every 8-bit non-negative integer can be represented in the form

z₁±z₂, where z₁ ε{1·2^{k}, 3·2^{k}, 5·2^{k}, 7·2^{k}, 11·2^{k}, 13·2^{k}},
z₂ ε{1·2^{k}, 3·2^{k}, 5·2^{k}, 7·2^{k}, 11·2^{k}, 119·2^{k}}
for k=0, 1, . . . 8.

Note that the first summand, z₁, is always positive, so one does not need to assign a special bit for its sign. The two sets of digits are Dₐ={1, 3, 5, 7, 11, 13} and D_{b}={1, 3, 5, 7, 11, 119}. The B processing can be carried out as follows:

3·B=B<<1+B=B₁/1 addition;

5·B=B<<2+B/1 addition;

7·B=B<<3−B=B₂/1 subtraction;

11·B=B<<2+B 2/1 addition;

13·B=B₁<<2+B/1 addition;

119·B=B₂<<4+B₂/1 addition;

The overall number of additions/subtractions is 6, which is the minimal possible. The critical path is two, which is also the minimal possible amongst all digit sets that ensure the representation of every 8-bit integer and that require only 6 additions to generate all the multiples of 5. Now, it is easy to estimate that this encoding scheme guarantees the implementation of multiplication by any 64-bit number with at most 21 additions/subtractions; and, what is even more important, it can be done very quickly.

TABLE 8
Representations with the smallest maximum numbers of
additions/subtractions for k = 64, 128, and 256

| | | | Additions/ |
|---|---|---|---|
| k | w | Digit sets | subtractions |
| 64 | 11 | {1, 3, 5, 7}, {1, 3, 5, 7}, {1, 3, 5, 7} | 20 |
| 128 | 8 | {1, 3, 5, 7, 11, 13}, {1, 3, 5, 7, 11, 119} | 37 |
| 256 | 8 | {1, 3, 5, 7, 11, 13}, {1, 3, 5, 7, 11, 119} | 69 |

In the case of the 64×64-bit multiplication, this new encoding scheme does not have advantages over the one proposed with the 7-bit windowing, which also guarantees 21 additions/subtractions with less complicated encoding scheme and a smaller LUT. However, in the case of the 128×128-bit multiplication, the new encoding is superior: It requires only 37 additions/subtractions, whereas the 7-bit windowing requires 40 additions/subtractions.

In some embodiments it is beneficial to use windows of size 6 (at least) and 11 (at most) for multiplication of integers of medium size: 64×64, 128×128 and 256×256. For sizes that would be useful, e.g., in RSA cryptography, one may need larger windows if the hardware resources allow.

The results allow us to provide some highly non-trivial upper bounds on the number of additions/subtractions sufficient to implement a k×k-bit multiplication for different k. Table 8 provides information for k=64, 128, and 256 and the corresponding encoding of the multiplicands that guarantee these upper bounds.

### Results and Comparisons

Several multipliers using the above discussed representations were described in VHDL in order to find out how they perform in practice. The representations used in these multipliers are collected in Table 9. They were carefully selected from many possibilities because they appeared to have very attractive features in theory and/or practice as discussed in the previous sections. Notice that the design depicted in FIG. 2 is a 32-bit version of mult_{—}7b2d, which uses a 7-bit window and two digit sets.

TABLE 9
Selected representations

| Name | w | Digit sets |
|---|---|---|
| mult_6b2d7 | 6 | {1, 3 5 7}, {1, 3}^{†} |
| mult_6b2d9 | 6 | {1, 3, 5, 9}, {1, 3} |
| mult_6bsms | 6 | {1, 3, 5, 7}, {1, 3, 5, 7}^{†‡} |
| mnlt_7b2d | 7 | {1, 3, 5, 7}, {1, 3, 5, 7}^{†} |
| mult_7bsms | 7 | {1, 3, 5, 7, 89, 125}, {1, 3, 5, 7, 89, 125}^{†‡} |
| mult_8b2dd | 8 | {1, 3, 5, 7, 11, 13}, {1, 3, 5, 7, 11, 119}^{†} |
| mult_8b2di | 8 | {1, 3, 5, 7, 11, 15, 19, 25}, {1, 3, 5, 7, 11, 15, 19, |
| | | 25}^{†} |
| mult_8b3d | 8 | {1}, {3}, {7, 17} |
| mult_8bsms | 8 | {1, 3, 5, 7, 11, 13, 15}, {1, 3, 5, 7, 11, 13, 15}^{†‡} |
| mult_9b2d | 9 | {1, 3, 5, 7, 11, 13, 15}, {1, 3, 5, 7, 11, 13, 15}^{†} |
| mult_11b3d | 11 | {1, 3, 5, 7}, {1, 3, 5, 7}, {1, 3, 5, 7}^{†} |

^{†}The 1st term is always positive,
^{‡}The 2nd term is always negative

32-bit and 64-bit multipliers based on the representations of Table 9 have been synthesized for both 0.18 μm CMOS and Altera Cyclone III FPCA. The proposed algorithms are mainly aimed at ASIC design; however, FPGA designs are faster to evaluate and relatively inexpensive and, at the same time, serve as a guiding line for possible optimizations and improvements.

### 0.18 μm CMOS Implementation

Synopsys Design Compiler Ultra (SDCU) has been used as an ASIC synthesis tool. By changing parameters in the synthesis process, we obtained a set of results for two different reference multipliers. The first reference was constructed with a simple linear adder array as partial product accumulator and ripple-carry adder as the final adder. In the second reference multiplier, we used radix-8 Booth encoding to generate partial products, vertical compressor slice (VCS) technique [50] for partial product reduction, and ripple-carry adder for final adder [51], [52]. Note that we can have many numbers of different architectures as a reference multiplier [53], [54], [55], [56], [57]. However, we selected aforementioned multipliers to have a reasonable comparison between the disclosed multipliers, classical multiplier (array based), and radix-8-based multiplier.

Area complexity and power consumptions of the disclosed 32-bit and 64-bit multipliers are collected in Table 10. We have collected results for both reference multipliers: array-based multiplier and radix-8 multiplier. The area and power consumption of the disclosed multipliers are compared to those of the radix-8-based multiplier because it is the better reference multiplier. These results for the disclosed multipliers were obtained by synthesizing VHDL with SDCU [58] Version B-2008.09 using Synopsys Design Ware IP [59] library with target clock frequency set to 50 MHz for 0.18 μm CMOS technology. (This leads timing constraint set to 20 ns per clock cycle.)

TABLE 10
Results in 0.18/μm CMOS

| | 32 × 32-bit | | | | 64 × 64-bit | | | |
|---|---|---|---|---|---|---|---|---|
| | Area | | Power | | Area | | Power | |
| Design | μm² | Ratio | mW | Ratio | μm² | Ratio | mW | Ratio |
| mult_ref (array) | 115,127 | 1.77 | 3.36 | 1.39 | 958,871 | 2.25 | 40.50 | 1.73 |
| mult_ref (Radix-8) | 65,207 | 1.00 | 2.42 | 1.00 | 425,936 | 1.00 | 23.63 | 1.00 |
| Mult_5bsms | 94,566 | 1.45 | 4.42 | 1.83 | 340,733 | 0.80 | 18.37 | 0.78 |
| mult_6b2d7 | 127,238 | 1.95 | 4.94 | 2.04 | 355,615 | 0.83 | 20.08 | 0.85 |
| mult_6b2d9 | 111,524 | 1.71 | 5.75 | 2.38 | 409,244 | 0.96 | 22.72 | 0.96 |
| mult_6bsms | 88,675 | 1.36 | 3.63 | 1.50 | 303,085 | 0.71 | 15.12 | 0.64 |
| mult_7b2d | 130,002 | 1.99 | 4.96 | 2.05 | 341,395 | 0.80 | 17.14 | 0.73 |
| mult_7bsms | 109,648 | 1.68 | 5.63 | 2.33 | 370,548 | 0.87 | 21.97 | 0.93 |
| mult_8b2dd | 128,772 | 1.97 | 5.27 | 2.18 | 406,732 | 0.95 | 20.47 | 0.87 |
| mult_8b2di | 135,355 | 2.08 | 5.47 | 2.26 | 422,227 | 0.99 | 21.20 | 0.90 |
| mult_8b3d | 153,606 | 2.36 | 6.35 | 2.62 | 456,818 | 1.07 | 23.09 | 0.98 |
| mult_8bsms | 117,156 | 1.80 | 4.75 | 1.96 | 378,571 | 0.89 | 18.17 | 0.77 |
| mult_9b2d | 139,180 | 2.13 | 5.37 | 2.22 | 433,952 | 1.02 | 21.11 | 0.89 |
| mult_11b3d | 205,944 | 3.16 | 5.65 | 2.33 | 572,620 | 1.34 | 21.38 | 0.90 |

Remark 1. In the disclosed reference multiplier synthesis results, we noticed that the area increase from 32-bit to 64-bit multiplier is more than a factor of four. This is because 20-ns constraint has become too tight for the 64-bit reference multiplier. Synthesizer sizes up many cells, simplifies full adders to simple gates, and restructures the logic, resulting in a much larger area. This alone can result in a factor of two or more. Because the size factor between a 32-bit and a 64-bit reference multiplier is naturally four. These together ensue in a factor of eight in the final results.

According to the results presented in Table 10, all of the currently described multipliers provide improvements over the array-based reference multiplier in both area and power in 64-bit multiplication. Further, all of the disclosed multipliers outperform radix-8 reference multiplier in 64-bit multiplication in terms of power consumption. Most of the disclosed multipliers have better area figures than radix-8 reference multiplier.

Some of the disclosed multipliers are better in terms of area than an array-based reference multiplier in 32-bit multiplication. All of the disclosed multipliers have more power consumption than both reference multipliers in 32-bit multiplication. The area consumption of 32-bit radix-8 multiplier is always better than any of the disclosed multipliers. In this comparison, the mult_{—}6bsms design has the best performance in both area and power consumption among the currently disclosed designs.

The results show the delicacy of selecting the representations. The quality of the results varies considerably even between representations which, at first sight, have only little difference. The effects of the conditions discussed in the “MULTIPLIER STRUCTURE” Section above are clearly visible in the results. For instance, the “something-minus-something” (SMS) encodings, where the first term is always positive and the second term is negative, show an advantage over other encodings with the same w.

The sizes of the encoders start to play a significant role in the area complexity when w increases. This diminishes the feasibility of representations with large I, such as mult_{—}11b3d, although they appear attractive in theory because of the low total number of additions/subtractions.

### FPGA Implementation

FPGAs have been used for design iterations and prototyping. The results for the best of the disclosed multipliers and the reference multiplier on Altera Cyclone III EP3C40F780C7 are collected in Table 11. They were collected by compiling the designs in Quartus II 8.1.

TABLE 11
Results on Altera Cyclone III FPGA of mult_6bsms

| | 32 × 32-bit | | | | 64 × 64-bit | | | |
|---|---|---|---|---|---|---|---|---|
| | Area | | Power | | Area | | Power | |
| Design | LUTs | Ratio | ns | Ratio | LUTs | Ratio | ns | Ratio |
| mult_ref | 1423 | 1.00 | 18.39 | 1.00 | 5706 | 1.00 | 2617 | 1.00 |
| mult_6bsms | 2302 | 1.62 | 21.03 | 1.14 | 8580 | 1.50 | 27.22 | 1.04 |

Large windows, w, may be unsuitable for FPGAs because the sizes of the encoders begin to dominate and the best results were achieved with mult_{—}6bsms which uses window size w=6. Table 11 shows the results for both mult_ref and mult_{—}6bsms. It shows that the gap between the reference multiplier and the disclosed multipliers is diminishing. The reference multipliers very strictly follow the rule that doubling the size of the operands leads to quadrupling the area complexity: 5706/1423=4.0098. For the disclosed multiplier the area complexity increment is: 8580/2302=3.727. Encodings with larger windows have even smaller increment factors although the absolute area consumptions are larger. In terms of time complexity, again, the gap is diminishing.

### DBNS Multiplier Using Booth Encoding

In some embodiments, the encoding of the multiplying apparatus 100 may use booth encoding. In one example, the architecture discussed above for the partial result generator is used. However, in this example optimized digit combinations for the multiplier are discussed. If a block of one of the multiplicands is represented in the something-minus-something (SMS) scheme x2^{a}−y2^{b}, ASIC implementation of the multiplier may give better area and power consumption. When the hardware implementation is carried out one may consider a few conditions to obtain improvements from the SMS scheme. For example, the:
1) size of the look-up-table should be limited;
2) choice of x and y should be in a set of integers S with minimal cardinality; and
3) exponents a, and b should be limited to powers of two.

The first condition should be satisfied to minimize area occupied by the LUT. In some of the embodiments disclosed above, only positive number representations for a given block were considered. In that case, by increasing the size of the block by one bit, the size of LUT doubles. Therefore the area growth is exponential relative to the size of the block. For example, assume block size is five. According to some of the embodiments disclosed above, the LUT has 2⁵ locations.

If the block size is w bits, one can write the number k represented in the i^{th} block as follows:

k=2^{iw}(2^{w-1}b_{w-1}+ . . . +2²b₂+2₁+b₀),

where bⱼ is the j^{th} bit in binary representation of the i^{th} block. If one considers Booth's approach for a given block, one can reduce the size of LUT to half compared to the previous approach. However, some additional circuitry is required to handle negation of the representation when required. The following equation gives the corresponding value of k obtained with a Booth approach for a w-bit size block.

k=2^{iw}(−2^{w-1}b_{w-1}+ . . . +2²b₂+2b₁+b₀+b₋₁),

where b₋₁ is the most significant bit of (i−1)^{St} block. If i=0 then b₋₁=0.

During the hardware implementation of the disclosed multipliers, one may have to precompute some values and use multiplexers to select them depending on the values for x and y. These precomputations need some adders or subtractors which again increase the area of the multiplier. One can reduce the area added by precomputations if one minimizes the cardinality of the set S. Additionally, maximum number of integers of power of two can be used in the digit set S to eliminate adders or subtractors.

In some embodiments, the hardware implementation of the disclosed multipliers need barrel shifters to implement 2^{a} and 2^{b}. This can significantly increase the area of the multiplier. Therefore, one may restrict the powers of two, a and b to keep it low as much as possible.

Optimal number combinations for block sizes of five and six are presented in Table 12.

TABLE 12
Digit Sets for Multiplier

| Design | w | x, y | a, b |
|---|---|---|---|
| b4bsms | 5 | {−4, 1, 3, 8} | {0, 1} |
| b5bsms | 6 | {−3, 1, 4, 5} | {0, 1, 2, 3} |

In one embodiment the encoder in FIG. 2 is designed with a LUT to represent all non-negative numbers that can be represented within the block of size w. The sms encoding may be used with values given in Table 5.

If the block size is five, 11 can be represented with x=3, y=r, a=0 and b=1:

11=(3)2⁰−(−4)2¹.

The values −4, 1, 3, and 8 are represented by 00, 01, 10, and 11 respectively. Then 11 is encoded with b4bsms into:

$$b 4 bsms ( 11 ) = \underbrace{10}_{x} \underbrace{0}_{a} \underbrace{00}_{y} \underbrace{1}_{b}$$

If the block generates a negative number, the contents of each corresponding location in the LUT must be shifted cyclically by half of width number of bits. For example when −11 is encoded using b4bsms the inventors obtain:

b4bsms(−1)=00 1 10 0

Then the encoded signals are used for controlling two multiplexers and barrel shifters in the partial result blocks as shown in FIG. 1. Once the partial products are generated by the disclosed encoding, the use of the following VHDL statement may be used to generate the functionality of partial product accumulator and final stage adder.

c<=ppn+ . . . +pp1+pp0;

where ppi is the partial product signal generated by i^{th} partial product result block and c is the signal that represents final result.

Table 13 compares the performance of various multipliers. The Radix-8 Booth encoding multiplier (“Booth”) uses a vertical compressor slice (VCS) technique for partial product reduction and ripple-carry adder as the final stage adder.

The ASIC implementation results obtained for modified booth encoding, b4bsms and b5bsms multipliers are summarized in the Table 13. 6bsms refers to a 6-bit window and “something-minus-something” encoding, for example.

TABLE 13
ASIC Synthesis Results Comparison

| | | | reduction^{a} | | decrease^{b} |
|---|---|---|---|---|---|
| | size | area | in area | power | in power |
| Design | (bits) | (μm²) | (%) | (mW) | (%) |
| Booth | 32 | 65,207 | — | 2.42 | — |
| 6bsms | | 88,675 | −26 | 3.63 | −33 |
| b4bsms | | 80,569 | −19 | 4.28 | −43 |
| b5bsms | | 86,556 | −25 | 5.52 | −56 |
| Booth | 64 | 425,936 | — | 23.63 | — |
| 6bsms | | 303,085 | 41 | 15.12 | 56 |
| b4bsms | | 271,018 | 57 | 15.61 | 51 |
| b5bsms | | 284,001 | 20 | 20.12 | 17 |
| Booth | 128 | 1,618,982 | — | 94.24 | — |
| 6bsms | | 1,050,846 | 54 | 67.64 | 39 |
| b4bsms | | 958,569 | 69 | 54.09 | 74 |
| b5bsms | | 971,801 | 67 | 83.20 | 13 |
| Booth | 192 | 3,528,775 | — | 195.48 | — |
| 6bsms | | 2,290,283 | 54 | 114.90 | 70 |
| b4bsms | | 2,066,114 | 71 | 112.46 | 74 |
| b5bsms | | 2,056,899 | 72 | 119.77 | 63 |
| Booth | 256 | 5,639,386 | — | 304.05 | — |
| 6bsms | | 4,002,381 | 41 | 207.62 | 46 |
| b4bsms | | 3,573,166 | 58 | 204.24 | 49 |
| b5bsms | | 3,560,715 | 58 | 297.64 | 2 |

^{(a)}Reduction in area is given against the radix-8 modified booth encoded multiplier.
^{(b)}Decrease in power is given against the radix-8 modified booth encoded multiplier.

The results for the disclosed multipliers were obtained by synthesizing VHDL with Synopsys Design Compiler Ultra Version B-2008.09 using Synopsys Design Ware IP library with target clock frequency set to 50 MHz (This leads timing constraint set to 20 ns per clock cycle.) for 0.18 μm CMOS technology.

According to the results described in Table 13, the disclosed multipliers are better than reference multipliers in terms of both area and power consumption when the size of the multiplier grows. Specifically, the disclosed encoding provides for better area when the size of the input grows. The b5bsms encoded multiplier overtakes the b4bsms encoded multiplier at the 177-bit size. Therefore, the b5bsms encoding gives better area and power consumption for very large multipliers. Also, even at 64-bit size the disclosed multipliers are better than the reference multiplier.

### Example Applications

There are many possible applications of the disclosed multipliers, in part, because multiplication is such a central operation in basically all digital systems. However, the fact that the disclosed multipliers become better than the existing solutions only when the operands are wider than a certain threshold naturally sets some limits for the applications of these multipliers.

One particularly interesting application is the possibility to use the disclosed multiplier in floating point operations. The floating point number systems used in practice typically represent numbers as described in the IEEE Standard for Binary Floating-Point Arithmetic (IEEE 754) [61] which includes 32-bit (single precision), 64-bit (double precision), and 128-bit (quadruple precision) versions. In all of them, one bit signifies the sign. The exponents are represented with 8, 11, or 15 bits and the fraction is given by 23, 52, or 112 bits for single, double, and quadruple precision, respectively. A floating point multiplication requires a multiplication of the fractions, e.g., a 52×52-bit multiplication for double precision and, consequently, a floating point processor must have support for multiplications with large operands.

The schematic flow chart diagrams that follow are generally set forth as logical flow chart diagrams. As such, the depicted order and labeled steps are indicative of one embodiment of the presented methods. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, a plurality of partial results may be produced before a plurality of multiples of a second interger are produced. Additionally, the order in which a particular method occurs may or may not strictly adhere to the order of the corresponding steps shown.

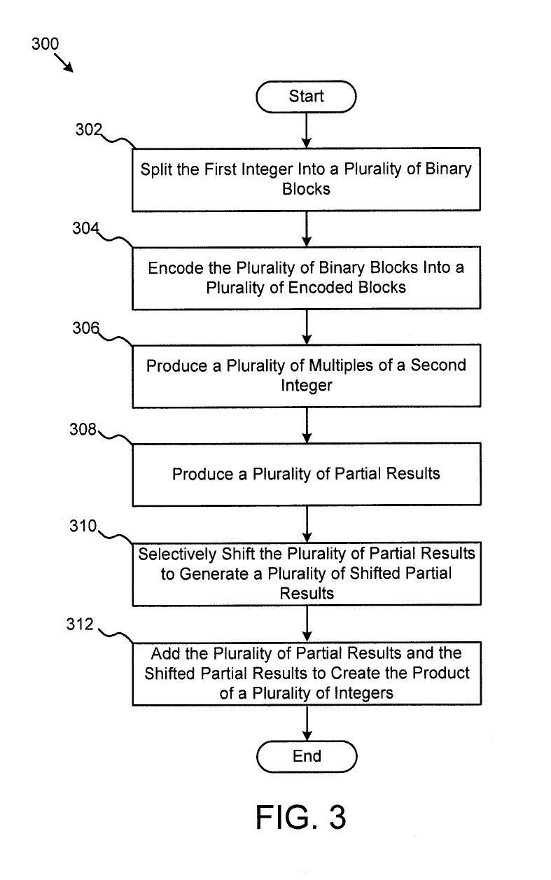

FIG. 3 illustrates one embodiment of a method 300 for multiplying integers in a multiplier. The method 300 includes splitting 302 a first integer into a plurality of binary blocks. The binary blocks may have different widths. The method 300 may also include encoding 304 the plurality of binary blocks into a plurality of encoded blocks. Additionally, the method 300 may include producing 306 a plurality of multiples of a second integer. The method 300 may also include producing 308 a plurality partial results. In addition, the method 300 may include selectively shifting 310 the plurality of partial results to generate a plurality of shifted partial results, and adding 312 the plurality of partial results and the shifted partial results to create the product of a plurality of integers.

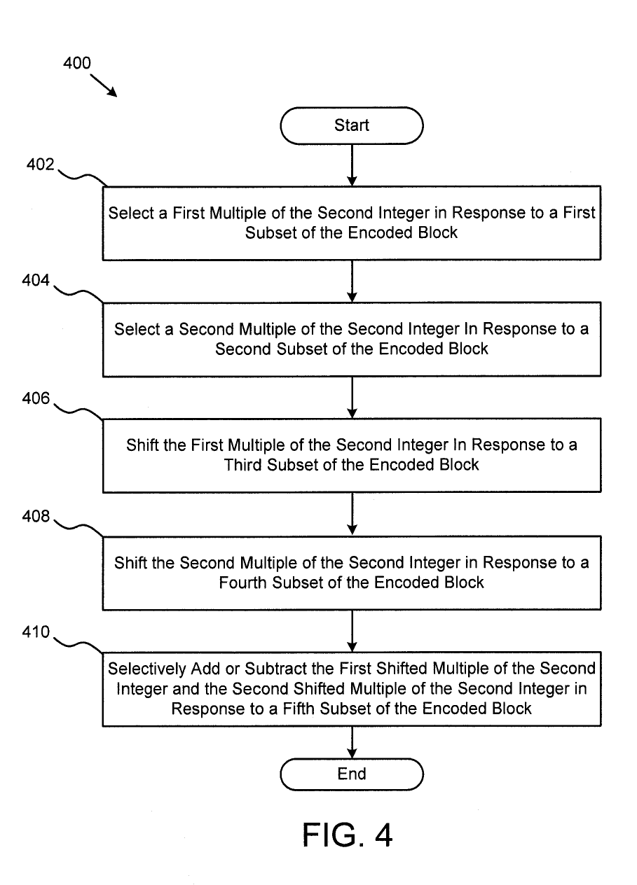

FIG. 4 illustrates one embodiment of producing 400 the partial results may include selecting 402 a first multiple of the second integer in response to a first subset of the encoded block, and selecting 404 a second multiple of the second integer in response to a second subset of the encoded block. Additionally, producing 400 the partial result may include shifting 406 the first multiple of the second integer in response to a third subset of the encoded block, and shifting 408 the second multiple of the second integer in response to a fourth subset of the encoded block. In still a further embodiment, producing 400 the partial results may include selectively adding or subtracting 410 the first shifted multiple of the second integer and the second shifted multiple of the second integer in response to a fifth subset of the encoded block.

In one embodiment, the plurality of encoded blocks correspond to a number in a double-base numbering system. The first multiple may be selected from the plurality of multiples of the second integer. In a further embodiment, the second multiple is selected from the plurality of multiples of the second integer. The partial results may also be selectively shifted in response to at least one of the width of the binary block and the position of the binary block.

In one embodiment, the multiples of the second integer include 1, 3, 5, and 7 times the second integer. Alternatively the multiples of the second integer may include 1, 3, 5, 7, 11, and 13 times the second integer. In still another embodiment, the multiples of the second integer include 1, 3, 5, 7, 11, and 119 times the second integer.

In particular embodiments, the method steps described above may be carried out by a processing device, such as an ASIC or FPGA, or the like.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

### REFERENCES

[1] A. N. Kolmogorov, “Asymptotic characteristics of some completely bounded metric spaces,” Doki. Akad. Nauk. SSSR, vol. 108, pp. 585-589, 1956.
[2] A. Karatsuba and Y. Ofman, “Multiplication of multidigit numbers on automata,” Soviet Physics Dokiady, vol. 7, no. 7, pp. 595-596, January 1963.
[3] D. E. Knuth, Art of Computer Programming, Volume 2: Seminumerical Algorithms, 3rd ed. Addison-Wesley Professional, November 1997.
[4] D. Zuras, “More on squaring and multiplying large integers,” IEEE Trans. Comput., vol. 43, no. 8, pp. 899-908, 1994.
[5] V. Strassen, “Gaussian elimination is not optimal,” Numerische Mathematik, vol. 13, no. 3, pp. 354-356, 1969.
[6] A. Schonhage and V. Strassen, “Schnelle multiplikation groβer zahlen,” Computing, vol. 7, pp. 281-292, 1971.
[7] M. Fürer, “Faster integer multiplication,” in Proceedings of the thirty-ninth annual ACM symposium on Theory of computing. San Diego, Calif., USA: ACM, 2007, PP. 57-66.
[8] S. A. Cook, “On the minimal computation time of functions,” Ph.D. dissertation, Harvard University, 1966.
[9] V. Lefévre, “Multiplication by an integer constant,” INRIA a CCSD electronic archive server based on Laboratorie dâlnformatique du Parellelisme, Lyon, France, Tech. Rep., 2000.
[10] R. Pinch, “Asymptotic upper bound for multiplier design,” Electronics Letters, vol. 32, no. 5, pp. 420-421, February 1996.
[11] V. S. Dimitrov, L. Imbert, and A. Zakaluzny, “Multiplication by a constant is sublinear,” in Proceedings of the 18th IEEE Symposium on Computer Arithmetic, 2007. ARITH18, June 2007, pp. 261-268.
[12] V. S. Dimitrov, L. Imbert, and P. K. Mishra, “The double-base number system and its application to elliptic curve cryptography,” Mathematics of Computation, vol. 77, no. 262, pp. 1075-1104., December 2007.
[13] P. Erdos, C. Pomerance, and E. Schmutz, “Carmichael's Lambda Function,” Acta Arithmetica, vol. 58, no. 4, pp. 363-385, 1991.
[14] V. S. Dimitrov and E. W. Howe, “Lower Bounds on the Lengths of Double-Base Representations,” January 2010.
[15] V. S. Dimitrov, G. A. Jullien, and W. C. Miller, “An algorithm for modular exponentiation,” Inf. Process. Lett., vol. 66, no. 3, pp. 155-159, 1998.
[16] R. Tijdeman, “On the maximal distance between integers composed of small primes,” Compositio Mathematica, vol. 28, pp. 159-162, 1974.
[17] A. Baker, “Linear forms in the logarithms of algebraic numbers IV,” Mathematika, vol. 16, pp. 204-216, 1968.
[18] M. Mignotte and M. Waldschmidt, “Linear forms in two logarithms and Schneider's method. III,” Faculté des Sciences. Annales. Mathématiques. Série (5), vol. Suppl., pp. 43-75, 1990.
[19] V. S. Dimitrov and T. V. Cooklev, “Hybrid algorithm for the computation of the matrix polynomial I+A+ . . . +A^{N-1},” IEEE Transactions on Circuits and Systems I: Fundamental Theory and Applications, vol. 42, no. 7, pp. 377-380, July 1995.
[20] V. S. Dimitrov and G. A. Jullien, “Loading the bases: a new number representation with applications,” Circuits and Systems Magazine, IEEE, vol. 3, no. 2, pp. 6-23, 2003.
[21] G. Jullien, V. S. Dimitrov, B. Li, W. C. Miller, A. Lee, and M. Ahmadi, “A hybrid DBNS processor for DSP computation,” in Proceedings of the IEEE International Symposium on Circuits and Systems, ISCAS '99, vol. 1, July 1999, pp. 5-8.
[22] R. Muscedere, V. S. Dimitrov, G. A. Jullien, and W. C. Miller, “Efficient techniques for binary-to multidigit multidimensional logarithmic number system conversion using range-addressable look-up tables,” IEEE Trans. Comput., vol. 54, no. 3, pp. 257-271, 2005.
[23] R. Muscedere, V. S. Dimitrov, G. A. Jullien, and W. C. Miller, “A low-power two-digit multi-dimensional logarithmic number system filterbank architecture for a digital hearing aid,” EURASIP Journal on Applied Signal Process., vol. 18, pp. 3015-3025, 2005.
[24] R. Muscedere, V. S. Dimitrov, O. A. Jullien, W. C. Miller, and M. Ahmadi, “On efficient techniques for difficult operations in one and two-digit dbns index calculus,” in Proceedings of the Thirty-Fourth Asilomar Conference on Signals, Systems and Computers, vol. 2, 2000, pp. 870-874.
[25] S. M. Kilambi and B. Nowrouzian, “A novel genetic algorithm for optimization of FRM digital filters over DBNS multiplier coefficient space based on correlative roulette selection,” in Proceedings of the IEEE International Symposium on Signal Processing and Information Technology, August 2006, pp. 228-231.
[26] P. Mercier, S. M. Kilambi, and B. Nowrouzian, “Optimization of FRM FIR digital filters over CSD and CDBNS multiplier coefficient spaces employing a novel genetic algorithm,” Journal of Computers, vol. 2, no. 7, pp. 20-31, 2007.
[27] M. Azarmehr and R. Muscedere, “A Simple Central Processing Unit with Multi-Dimensional Logarithmic Number System Extensions,” Proc. IEEE Int'l Conf. Application-Specific Systems, Architectures and Processors (ASAP), pp. 342-345, July 2007.
[28] V. S. Dimitrov, K. U. Järvinen, M. J. Jacobson Jr., W. F. Chan, and Z. Huang, “Provably sublinear point multiplication on Koblitz curves and its hardware implementation,” IEEE Trans. on Computers, vol. 57, no. 11, pp. 1469-1481, 2008.
[29] V. S. Dimitrov, L. Imbert, and P. K. Mishra, “Efficient and secure elliptic curve point multiplication using Double-Base chains,” in Proceedings of the Advances in Cryptology—ASIA CRYPT '05, ser. Lecture Notes in Computer Science, vol. 3788. Springer, 2005, pp. 59-78.
[30] R. Avanzi, V. S. Dimitrov, C. Doche, and F. Sica, “Extending scalar multiplication using double bases,” in Proceedings of the Advances in Cryptology—ASIA CRYPT '06, vol. 4284. Springer, 2006, pp. 130-144.
[31] M. Ciet and F. Sica, “An analysis of double base number systems and a sublinear scalar multiplication algorithm,” in Proceedings of the Progress in Cryptology—Mycrypt '05, vol. 3715. Springer, 2005, pp. 171-182.
[32] C. Doche and L. Imbert, “Extended double-base number system with applications to elliptic curve cryptosystem,” in Proceedings of the Progress in Cryptology, INDOCRYPT '06, ser. Lecture Notes in Computer Science, vol. 4329. Springer, 2006, pp. 335-348.
[33] V. Berthé and L. Imbert, “On converting number to the double-base number system,” in Advanced Signal Processing Algorithms, Architectures and Implementations XIV, vol. 5559. In Proceedings of SPIE, 2004, pp. 70-78.
[34] V. S. Dimitrov and T. V. Cooklev, “Two algorithms for modular exponentiation using nonstandard arithmetic,” IEICE Trans. on Fundamentals, vol. E78-A, pp. 82-87, 1995.
[35] C.-Y. Chen, C.-C. Chang, and W.-P. Yang, “Hybrid method for modular exponentiation with precomputation,” Electronics Letters, vol. 32, no. 6, pp. 540-541, March 1996.
[36] C. Doche, D. Kohel, and F. Sica, “Double-Base Number System for multi-scalar multiplications,” in Proceedings of the EuroCrypt '09, ser. Lecture Notes in Computer Science, vol. 5479. Springer, 2009, pp. 502-519.
[37] C. Doche and L. Habsieger, “A tree-based approach for computing double-base chains,” in Proceedings of the 13th Australasian conference on Information Security and Privacy, ACISP '08. Berlin, Heidelberg: Springer-Verlag, 2008, pp. 433-446.
[38] J. Adikari, V. S. Dimitrov, and L. Imbert, “Hybrid binary-ternary joint form and its application in elliptic curve cryptography,” in Proceedings of the 19th IEEE Symposium on Computer Arithmetic, 2009. ARITH19, June 2009, pp. 76-83.
[39] K. W. Wong, E. C. W. Lee, L. Cheng, and X. Liao, “Fast elliptic scalar multiplication using new double base chain and point halving,” Applied Mathematics and Computation, vol. 183, no. 2, pp. 1000-1007, 2006.
[40] C. Zhao, F. Zhang, and J. Huang, “Efficient tate pairing computation using double-base chains,” Science in China Series F: Information Sciences, vol. 51, no. 8, pp. 1009-2757, 2008.
[41] D. J. Bernstein and T. Lange, “Analysis and optimization of elliptic-curve single-scalar multiplication,” Finite fields and applications, Contemporary Mathematics, vol. 461, pp. 1-19, 2008.
[42] R. Bernstein, “Multiplication by integer constants,” Software: Practice and Experience, vol. 16, no. 7, pp. 641-652, July 1986.
[43] J. D. Ullman, Computational Aspects of VLSI. New York, N.Y., USA: W.H. Freeman & Co., 1984.
[44] I. Wegener and R. Pruim, Complexity Theory: Exploring the Limits of Efficient Algorithms. Secaucus, N.J., USA: Springer-Verlag New York, Inc., 2005.
[45] W. J. Paul and P.-M. Seidel, “To Booth or Not to Booth,” The VLSI J., vol. 32, nos. ½, pp. 5-40, 2002.
[46] P. Kornerup, “Digit-Set Conversions: Generalizations and Applications,” IEEE Trans. Computers, vol. 43, no. 5, pp. 622-629, May 1994.
[47] D. W. Matula, “Basic Digit Sets for Radix Representation,” J. ACM, vol. 29, no. 4, pp. 1131-1143, 1982.
[48] P.-M. Seidel, L. McFearin, and D. Matula, “Secondary Radix Recordings for Higher Radix Multipliers,” IEEE Trans. Computers, vol. 54, no. 2, pp. 111-123, February 2005.
[49] D. Matula and P. Kornerup, “Finite Precision Rational Arithmetic: Slash Number Systems,” IEEE Trans. Computers, vol. 34, no. 1, pp. 3-18, January 1985.
[50] V. Oklobdzija, D. Villeger, and S. Liu, “A Method for Speed Optimized Partial Product Reduction and Generation of Fast Parallel Multipliers Using an Algorithmic Approach,” IEEE Trans. Computers, vol. 45, no. 3, pp. 294-306, March 1996.
[51] R. Zimmermann, “Datapath Synthesis for Standard-Cell Design,” Proc. 19th IEEE Symp. Computer Arithmetic (ARITH), pp. 207-211, 2009.
[52] R. Zimmermann and D. Tran, “Optimized Synthesis of Sum-of-Products,” Proc. Conf. Record of the 37th Asilomar Conf. Signals, Systems and Computers, vol. 1, pp. 867-872, 2003.
[53] A. D. Booth, “A Signed Binary Multiplication Technique,” The Quarterly J. Mechanics and Applied Math., vol. 4, no. 2, pp. 236-240, 1951.
[54] A. Avizienis, “Signed-Digit Number Representations for Fast Parallel Arithmetic,” IEEE Trans. Electronic Computers, vol. EC-10, no. 3, pp. 389-400, September 1961.
[55] C. S. Wallace, “A Suggestion for a Fast Multiplier,” IEEE Trans. Electronic Computers, vol. EC-13, no. 1, pp. 14-17, February 1964.
[56] L. Dadda, “Some Schemes for Parallel Multipliers,” Alta Frequenza, vol. 34, pp. 349-356, 1965.
[57] ARITH Research Group, “Arithmetic Module Generator Based on ARITH,” April 2010.
[58] Synopsys Inc., “Design Compiler Ultra,” April 2010.
[59] Synopsys Inc., “DesignWare IP,” April 2010.
[60] C. M. Skinner, “On the Diophantine equation ap^{x}+bq^{y}==c+dp^{z}q^{w},” Journal of Number Theory, vol. 35, no. 2, pp. 194-207, 1990.
[61] IEEE Computer Society, “IEEE standard for floating-point arithmetic,” IEEE 754-2008, 2008.

What is claimed is:

1. A method for multiplying integers in an integrated circuit, comprising:
splitting in an integrated circuit a first integer into a plurality of binary blocks;
encoding the plurality of binary blocks into a plurality of encoded blocks;
producing a plurality of multiples of a second integer;
producing a plurality of partial results from the plurality of encoded blocks and the plurality of multiples;
selectively shifting the plurality of partial results to generate a plurality of shifted partial results; and
adding at least one of the plurality of partial results and one of the shifted partial results to create the product of the first integer and the second integer.

2. The method of claim 1, wherein producing the partial results comprises:
selecting a first multiple of the second integer in response to a first subset of the encoded block;
selecting a second multiple of the second integer in response to a second subset of the encoded block;
shifting the first multiple of the second integer in response to a third subset of the encoded block;
shifting the second multiple of the second integer in response to a fourth subset of the encoded block; and
selectively adding or subtracting the first shifted multiple of the second integer and the second shifted multiple of the second integer in response to a fifth subset of the encoded block.

3. The method of claim 1, wherein the plurality of encoded blocks correspond to a number in a double-base numbering system.

4. The method of claim 3, where the double-base numbering system uses Booth encoding.

5. The method of claim 3, wherein the double base numbering system uses a 6-bit window and “something-minus-something” encoding.

6. The method of claim 3, wherein the double base numbering system uses a 5-bit window and “something-minus-something” encoding.

7. The method of claim 3, wherein the double base numbering system uses a 4-bit window and “something-minus-something” encoding.

8. The method of claim 2, wherein the first multiple is selected from the plurality of multiples of the second integer.

9. The method of claim 2, wherein the second multiple is selected from the plurality of multiples of the second integer.

10. The method of claim 1, wherein the partial results are selectively shifted in response to at least one of the width of the binary block and the position of the binary block.

11. The method of claim 1, wherein the multiples of the second integer comprise 1, 3, 5, and 7 times the second integer.

12. The method of claim 1, wherein the multiples of the second integer comprise 1, 3, 5, 7, 11, and 13 times the second integer.

13. The method of claim 1, wherein the multiples of the second integer comprise 1, 3, 5, 7, 11, and 119 times the second integer.

14. An apparatus comprising:
a splitter configured to convert a first integer into a plurality of binary blocks;
an encoder coupled to the splitter, the encoder configured to encode the plurality of binary blocks into a plurality of encoded blocks;
a processing module configured to produce a plurality of multiples of a second integer;
a partial results circuit coupled to the encoder and the processing module, the partial results circuit configured to produce a plurality partial results;
a shifter coupled to the partial results block, the shifter configured to selectively shift the plurality of partial results to generate a plurality of shifted partial results; and
an adder coupled to the shifter, the adder configured to add the plurality of partial results and the shifted partial results to create the product of a plurality of integers.

15. The apparatus of claim 14, wherein the partial results circuit is configured to:
select a first multiple of the second integer in response to a first subset of the encoded block;
select a second multiple of the second integer in response to a second subset of the encoded block;
shift the first multiple of the second integer in response to a third subset of the encoded block;
shift the second multiple of the second integer in response to a fourth subset of the encoded block; and
selectively add or subtract the first shifted multiple of the second integer and the second shifted multiple of the second integer in response to a fifth subset of the encoded block.

16. The apparatus of claim 14, wherein the plurality of encoded blocks correspond to a number in a double-base numbering system.

17. The apparatus of claim 16, where the double-base numbering system uses Booth encoding.

18. The method of claim 16, wherein the double base numbering system uses a 6-bit window and “something-minus-something” encoding.

19. The method of claim 16, wherein the double base numbering system uses a 5-bit window and “something-minus-something” encoding.

20. The method of claim 16, wherein the double base numbering system uses a 4-bit window and “something-minus-something” encoding.

21. The apparatus of claim 15, wherein the first multiple is selected from the plurality of multiples of the second integer.

22. The apparatus of claim 15, wherein the second multiple is selected from the plurality of multiples of the second integer.

23. The apparatus of claim 14, wherein the partial results circuit is further configured to selectively shift in response to at least one of the width of the binary block and the position of the binary block.

24. The apparatus of claim 14, wherein the multiples of the second integer comprise 1, 3, 5, and 7 times the second integer.

25. The apparatus of claim 14, wherein the multiples of the second integer comprise 1, 3, 5, 7, 11, and 13 times the second integer.

26. The apparatus of claim 14, wherein the multiples of the second integer comprise 1, 3, 5, 7, 11, and 119 times the second integer.
